(19) United States
(12) Patent Application Publication
(10) Pub. No.: US 2023/0396542 A1
(43) Pub. Date: Dec. 7, 2023

(54) EXPLICIT DATA PACKET CONTENT IDENTIFICATION FOR UTILITY DEVICES

(71) Applicant: Aclara Technologies LLC, St. Louis, MO (US)

(72) Inventors: Jeff Sumrall Anderson, St. Louis, MO (US); Christopher Keith Fleck, St. Louis, MO (US)

(21) Appl. No.: 18/205,905

(22) Filed: Jun. 5, 2023

Related U.S. Application Data
(60) Provisional application No. 63/349,477, filed on Jun. 6, 2022.

(51) Int. Cl. H04L 45/74; H04L 67/12; H04L 12/18

(52) U.S. Cl. CPC H04L 45/74; H04L 67/12; H04L 12/18

(57) ABSTRACT

A utility device within a utility system and including a power source, a communication interface, and one or more electronic processors. The processors are configured to periodically transition from a standby mode into a receive mode and monitor for a broadcast message while in the receive mode. The electronic processors are also configured to receive a broadcast message via the communication module while in the receive mode and analyze a header of the received broadcast message to determine whether any data packets within the received broadcast message is relevant. The data packets within the broadcast message are determined to be relevant based on whether the received broadcast message includes one or more data packets within one or more information regions associated with a device type of the utility device. The electronic processors are also configured to resume operation in the standby mode in response to determining that the received broadcast message is not relevant.

### CROSS-REFERENCE TO RELATED APPLICATIONS

This application claims priority to, and the benefit of, U.S. Provisional Patent No. 63/349,477, filed Jun. 6, 2022, the contents of which is hereby incorporated by reference.

### FIELD

Embodiments of the disclosure relate to efficiently routing messages to various devices within a network, such as a utility network system.

### BACKGROUND

Connected or smart utility meters and/or sensors are increasingly common in utility systems, e.g., gas, electric, water, etc. These connected sensors allow for data to be provided directly to a central utility system for processing, billing, maintenance, etc. Many of these devices rely on battery (or other energy storage device) power for operation. Often, these devices may have to be replaced in their entirety upon the power source being unable to provide sufficient power to the device (i.e., upon the battery dying). Much of the energy expended by these connected devices may relate to monitoring for, and the receiving of, messages such as those transmitted by a utility system. This is particularly true where broadcast messages are used by the utility system. The use of broadcast messages can require the devices to actively monitor for the entire duration of a transmitted broadcast message in the event one or more messages within the broadcast is directed to the device. This results in additional energy expenditure due to the device being required to be in a receive mode for an extended period of time.

### SUMMARY

The concepts described herein provide systems and methods for reducing unnecessary operation of a device in a receive mode by encoding broadcast messages with header information that allows devices to quickly determine whether or not the broadcasted message is relevant to said device. The encoded broadcast messages generally take advantage of characteristics of the utility device type (e.g., whether the device is a battery powered device or a mains powered device) and other parameters, such as a unique network ID of devices within the system. By reducing the time that a device is unnecessarily in the receive mode, the lifespan of the device (e.g., the battery life) may be extended.

In one embodiment, a utility device within a utility system and including a power source, a communication interface, and one or more electronic processors is described, according to some embodiments. The processors are configured to periodically transition from a standby mode into a receive mode and monitor for a broadcast message while in the receive mode. The electronic processors are also configured to receive a broadcast message via the communication module while in the receive mode and analyze a header of the received broadcast message to determine whether any data packets within the received broadcast message is relevant. The data packets within the broadcast message are determined to be relevant based on whether the received broadcast message includes one or more data packets within one or more information regions associated with a device type of the utility device. The electronic processors are also configured to resume operation in the standby mode in response to determining that the received broadcast message is not relevant.

In another embodiment, a process for generating broadcast messages within a utility network is described, according to some embodiments. The process includes generating a broadcast message that includes one or more data packets associated with one or more utility devices and generating a header for the generated broadcast message. The generated header includes data indicating the applicability of the included one or more data packets with the one or more utility devices. The process further includes transmitting the generated message.

In another embodiment, a process for analyzing broadcast messages at a utility device is described, according to some embodiments. The process includes periodically transitioning from a first mode to a second mode and receiving a broadcast message via a communication module while operating in the second mode. The process also includes analyzing a header of the received broadcast message to determine whether the received broadcast message includes one or more data packets within one or more information regions that are associated with a device type of the utility device. The process further includes determining whether the received broadcast message is a relevant message in response to determining that the received broadcast message includes one or more data packets within one or more information regions associated with the device type of the utility device and processing the received broadcast message in response to determining that the received broadcast message is a relevant broadcast message.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claims and explain various principles and advantages of those embodiments.

FIG. 1 is a diagram of a general utility network, according to some embodiments.

FIG. 2 is a block diagram of a utility device, according to some embodiments.

FIG. 3 is a flowchart illustrating a process for adding a utility device to a utility network, according to some embodiments.

FIG. 4 is a flow chart illustrating a process for generating a broadcast message for a utility network, according to some embodiments.

FIG. 5 is an example broadcast message format, according to some embodiments.

FIG. 6 is representation of a broadcast message including relevant utility devices, according to some embodiments.

FIG. 7 is a representation of the broadcast message of FIG. 6 with a minimum range exclusion zone, according to some embodiments.

FIG. 8 is a representation of the broadcast message of FIG. 6 with an outer exclusion zone, according to some embodiments.

FIG. 9 is a representation of the broadcast message of FIG. 6 with an inner exclusion zone, according to some embodiments.

FIG. 10 is a representation of the broadcast message of FIG. 6 with periodic exclusion zones, according to some embodiments.

FIG. 11 is a representation of the broadcast message of FIG. 6 with a combination of exclusion zone types, according to some embodiments.

FIG. 12 is a flow chart illustrating a process for processing a received broadcasted message, according to some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Before any embodiments of the disclosure are explained in detail, it is to be understood that the disclosure is not limited in its application to the details of construction and the arrangement of components set forth in the following description or illustrated in the accompanying drawings. The disclosure is capable of other embodiments and of being practiced or of being carried out in various ways.

One or more embodiments are described and illustrated in the following description and accompanying drawings. These embodiments are not limited to the specific details provided herein and may be modified in various ways. Furthermore, other embodiments may exist that are not described herein. Also, the functionality described herein as being performed by one component may be performed by multiple components in a distributed manner. Likewise, functionality performed by multiple components may be consolidated and performed by a single component. Similarly, a component described as performing specific functionality may also perform additional functionality not described herein. For example, a device or structure that is “configured” in a certain way is configured in at least that way but may also be configured in ways that are not listed. Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used herein, “non-transitory computer-readable medium” includes all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

Also, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between such entities or actions.

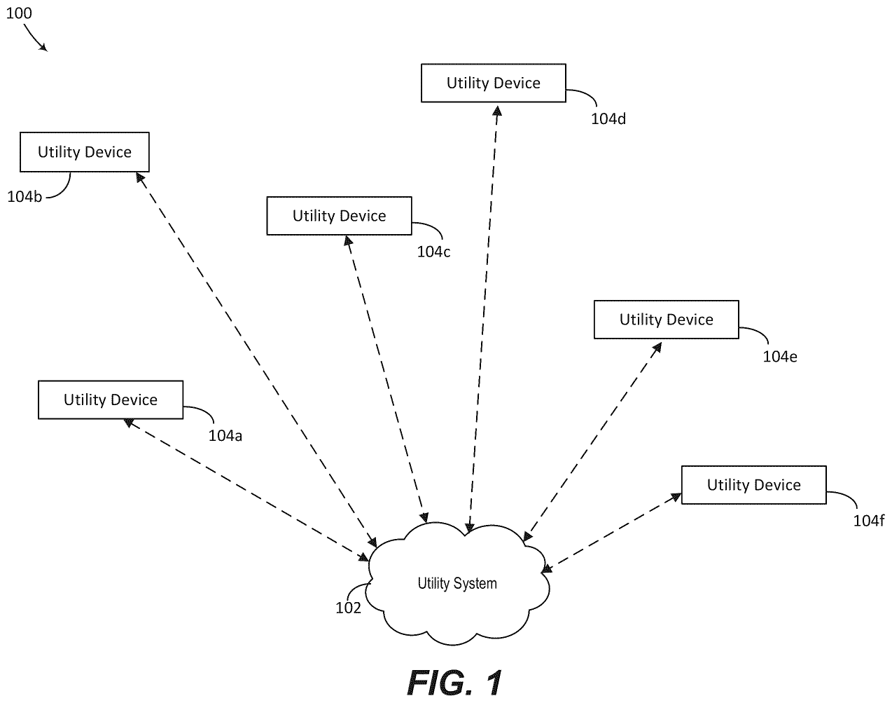

FIG. 1 illustrates a general utility network 100, according to some embodiments. The network 100 may include a utility system 102. The utility system 102 may be related to a specific utility (e.g., electric, gas, water, etc.), a specific region, a specific customer, and/or a combination thereof. In other examples, the utility system 102 may be any type of utility system configured to control or manage one or more aspects of a utility network, such as utility network 100. In one example, the utility system 102 may be or include a server or cloud-based system which allows the utility to monitor and/or control various aspects of an associated utility network 100. The utility network 100 may further include a number of utility devices 104a-104f. The utility devices may include meters, sensor modules, communication devices, etc. For example, the utility devices 104a-104f may include various sensor modules such as voltage sensors, current sensors, methane sensors, moisture sensors, flow sensors, level sensors, gas concentration sensors, tension sensors, position sensors, temperature sensors, wind sensors, electrical arc sensors, and/or any other sensor used within a utility system. The utility devices 104a-f may be configured to sense one or more parameters associated with a utility system, such as gas (e.g., methane), moisture, temperatures, electrical currents, voltages, electrical arcs, water or other liquid levels, gas pressures, and/or other parameters associated with a given utility system.

As shown in FIG. 1, the utility devices 104a-f are generally configured to communicate with the utility system 102. One or more of the utility devices 104a-f may communicate with the utility system 102 using a wireless communication protocol, such as Bluetooth, Wi-Fi, RF, LoRA, Wi-Max, a proprietary RF communication protocol, such as Aclara RF from Aclara Technologies, LLC, and/or other applicable wireless communication protocols to communicate data between the one or more utility devices 104a-f and the utility system 102. In some instances, one or more of the utility devices may communicate with the utility system 102 using a wired communication protocol, such as Ethernet, Firewire, USB, RS-232, or other applicable wired communication protocol.

Generally, the utility system 102 may broadcast one or more messages to communicate with the utility devices 104a-f. The broadcasted message may include a number of data packets for one or more of the utility devices 104a-f. However, the broadcasted message may not include data packets for some of the utility devices 104a-f. For example, a broadcast message may include data packets for utility devices 104a-104d, while not including any data packets related to utility devices 104d-104f. The data packets may include instructions for the one or more utility devices 104a-f, such as to vary a configuration of the respective utility device 104a-f, to provide/transmit data (e.g., sensor data) to the utility system 102, or other instruction as required for a given application. Systems and processes described herein are configured to allow for the utility devices 104a-f to efficiently determine whether a broadcasted message includes one or more data packets related to the specific utility device 104a-f.

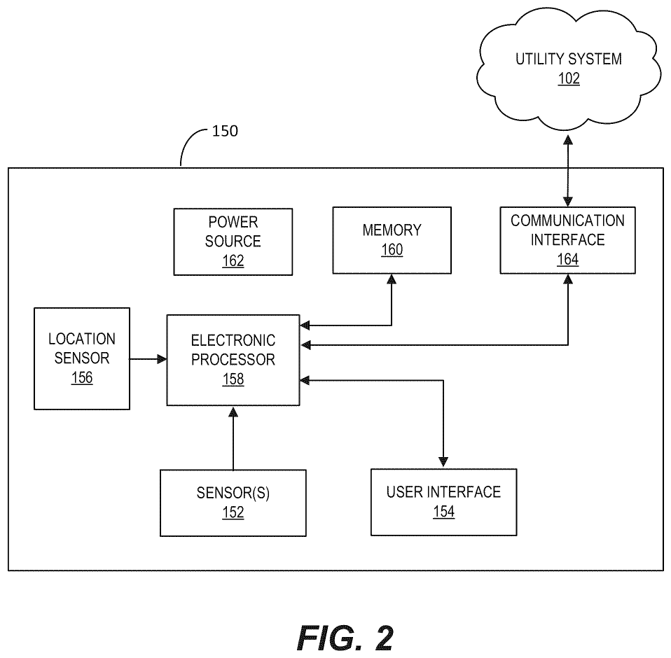

FIG. 2 is a block diagram of a utility device 150, according to some embodiments. The utility device 150 may be similar to the utility devices 104a-f described above in regard to FIG. 1 and should be understood to be able to be used interchangeably herein. Each utility device 150 may contain a housing (not shown) that is environmentally sealed. Such a housing may be manufactured with any suitable materials, including materials used for components used in exterior locations, such as external utility systems (meters, power lines, substations, etc.).

The utility device 150 may include one or more sensors 152. The sensors 152 may include gas detection sensors, gas concentration sensors, pressure sensors, voltage sensors, current sensors, temperature sensors, light sensors, corrosion detection sensors, chemical presence sensors, flow sensors, tilt sensors, vibration sensory, acceleration sensors, velocity sensors, volumetric sensors, pH sensors, conductivity sensors, oxidation sensors, chlorine sensors, chlorophyll sensors, algae sensors, humidity sensors, resistance sensors, inductance sensors, level sensors, sounds/acoustic sensors, proximity sensors, and/or other sensor as required for a given application. In one embodiment, the sensors 152 may be any sensors used in the gas, water, wastewater, or electric utility space. The utility device 150 may further include a user interface 154. The user interface 154 may include one or more inputs to allow a user, such as a technician, to control, modify, or otherwise provide instructions to the utility device 150, as will be described in more detail below. In some examples, the user interface 154 may further include a display to provide a visual indication of one or more parameters of the utility device 150, such as a communication status, sensor readings, configuration data, and/or other information as appropriate for a given application. In some embodiments, the display may serve as both an input device and an output device, such as where the display is a touchscreen device. The utility device 150 may further include a location sensor 156 (e.g., GPS, Glonass). The location sensor 156 may provide a location of the utility device 150.

As illustrated in FIG. 2, the utility device 150 further includes an electronic processor 158, a memory 160, a power source 162, and a communication interface 164. The sensors 152 and the location sensor 156 are configured to provide one or more sensed values to the electronic processor 158. The user interface 154 may both provide input to, and receive an output from, the electronic processor 158.

The memory 160 may include read only memory (ROM), random access memory (RAM), other non-transitory computer-readable media, or combinations thereof. The electronic processor 158 is configured to communicate with the memory 160 to store data and retrieve stored data. The electronic processor 158 is configured to receive instructions and data from the memory 160 and execute, among other things, various instructions, processes, applications, or the like. In particular, the electronic processor 158 executes instructions stored in the memory 160 to perform one or more of the processes described herein.

In one embodiment, the power source 162 is configured to provide power to the various components of the utility device 150. In some embodiments, the utility device 150 receives external power and the power source 162 converts and distributes the external power to the various components of the utility device 150. Utility devices 150 capable of, or configured to, receive power from an external source (e.g., mains power) are referred to as unconstrained devices. In some examples, the power source 162 includes a battery (e.g., lithium-ion, lithium-iron phosphate, nickel cadmium, etc.). In some instances, the battery may be the sole power source, or may be configured to provide backup power when external power is not available. Where the power source 162 is a battery (or other energy storage device) and the sole power (or used in conjunction with non-mains power, such as solar), the utility device 150 is referred to as a constrained device.

The communication interface 164 (e.g., a transceiver) allows for communication between the electronic processor 158 and one or more external devices, such as the utility system 102. In some embodiments, the communication interface 164 may include separate transmitting and receiving components. In one embodiment, the communication interface 164 includes a wireless transceiver configured to encode information received from the electronic processor 158 into a carrier wireless signal and transmit the encoded wireless signal to one or more external devices and/or communication networks, as described above. The communication interface 164 may also be configured to decode information received from one or more external devices and provides the decoded information to the electronic processor 158.

The communication interface 164 may communicate with devices and/or networks via various communication protocols, such as using a power line network or a wireless network (e.g., BLUETOOTH®, Wi-Fi, Wi-Max, cellular (3G, 4G, 5G, LTE), RF, LoRa, Zigbee, and/or other wireless communication protocols applicable to a given system or installation). In one embodiment, the communication interface 216 may use a proprietary wireless communication protocol, such as Aclara RF from Aclara Technologies, LLC. Furthermore, in one embodiment, the communication interface 164 may communicate using a combination of communication protocols, such as those described above. For example, the communication interface 164 may be configured to communication via a combination of cellular, BLUETOOTH, and a power line network, thereby allowing for the communication interface to communicate with multiple devices, such as the utility system 102 (FIG. 1). However, other combination of communication protocols are also applicable as appropriate for a given application.

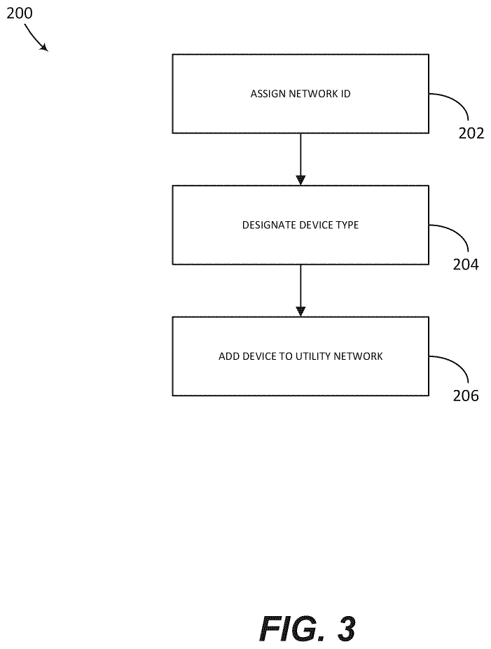

Turning now to FIG. 3, a process 200 for adding a device, such as utility device 150, to a utility network, such as utility network 100, is described according to some embodiments. At process block 202, a network ID is assigned to the utility device 150. In one embodiment, the utility devices 150 within a system may be assigned a unique network ID. In some examples, the unique network ID may an integer value from 1 to N, where N is the total number of utility devices 150 within a utility network. In other examples, the unique network ID may be an alpha-numeric value from 1 to N, where N is the total number of utility devices 150 within a utility network. The unique network ID may be a separate unique ID from a unique ID assigned to the utility device 150 during manufacturing. By assigning a unique network ID for all utility devices within the utility network 100, the utility system 102 may be able to more efficiently direct messages to one or more desired utility devices 150 within the utility network 100 as the unique network IDs assigned to the respective utility devices 150 fall within a limited set of values as described above.

In some examples, the utility system 102 may be configured to automatically generate the unique network ID based on the order in which the utility device 150 is added to the utility network 100. In other example, additional intelligence may be used when assigning a unique network ID to a utility device 104. For example, the assigned unique network ID may be based on a type of utility device (e.g., sensor, meter, communication module, etc.), such that devices of that type may have unique network IDs that are grouped together. In other examples, the assigned unique network ID may be based on a location of the utility device 104, such that devices within a certain region or location are grouped together. In still other examples, the unique network ID may be assigned based on the type of utility (e.g., Gas, Electric, Water, Sewage) associated with the utility device 150. It is understood that the unique network ID may be assigned using one or more of the above factors, or other considerations as required for a given application. In some examples, one or more multicast IDs may be assigned to the utility device 150 as well. The multicast IDs may relate to groups of utility devices 150 who are intended to receive a multicast message including a data packet intended for each device having the respective multicast ID.

At process block 204, a device type is assigned to the utility device 150. In some examples, the device type defines whether the device is a constrained device (e.g., battery powered) or unconstrained (e.g., mains powered) device. In other examples, other device characteristics, such as sensor types, device configurations, system associations, etc. may be assigned at process block 204.

At process block 206, the utility device 150 is added to the utility network 100. In some examples, the utility device 150 is added to the utility network by storing the unique device ID in the utility system 102, along with other characteristics of the utility device 150, such as device type, location, function, and/or other characteristic as required for a given application.

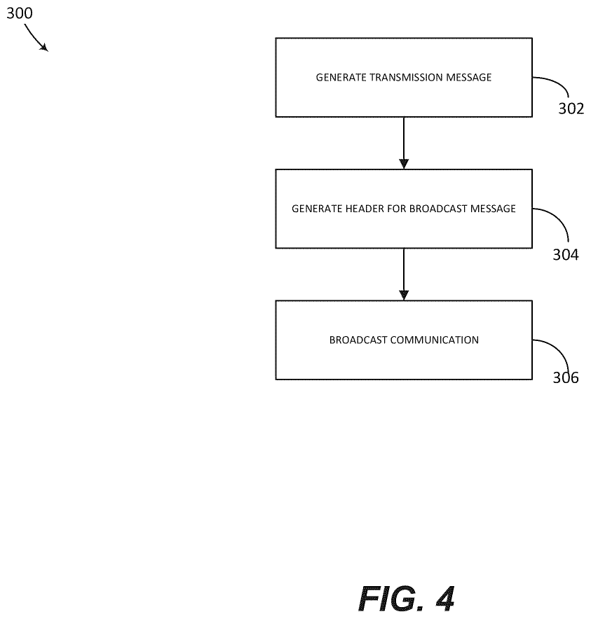

Turning now to FIG. 4, a process 300 for generating a broadcast message is described, according to some embodiments. For purposes of this disclosure, the process 300 will be described as being performed by the utility system 102. However, it is understood that one or more devices within the utility network 100 and/or network system 102 may perform some or all of the functions described associated with the respect to the process 300. As described above, broadcast messages may include multiple unicast messages having data packets for one or more utility devices 150 within the utility network 100. In some examples, the broadcast message may be for all utility devices 150 within the utility network 102. However, often the broadcast message includes unicast messages for a subset of utility devices 150 within the utility network 100. Thus, as will be described in more detail below, the broadcast message may be configured to include a header to allow for the utility devices to efficiently determine whether the broadcast message includes any relevant data packets for the receiving utility device. While broadcast messages are described above as including one or more unicast messages, it is contemplated that the process 300 may also apply to generate broadcast messages having multicast messages having data packets intended for groups of utility devices 150. For multicast messages, a multicast ID of a utility device 150 may be used in lieu of the unique network ID, as described above.

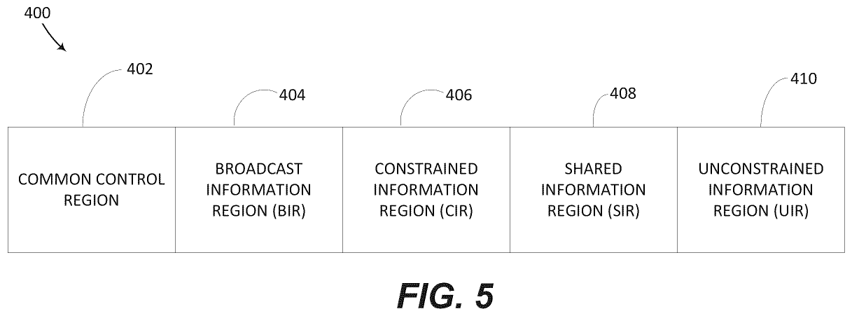

At process block 302, a transmission message is generated including one or more unicast messages intended for one or more utility devices 150 in the utility network 100. While not described, the transmission message may further include one or more multicast messages in addition to, or in lieu of, the unicast messages. As described above, the unicast messages may include data packets intended for the one or more utility devices 150. The generated transmission message may include a header and one or more information regions. Turning briefly now to FIG. 5, an example generated transmission message 400 is illustrated, according to some embodiments. The generated transmission message 400 includes multiple information regions, such as a common control region (“CCR”) 402, a broadcast information region (“BIR”) 404, a constrained device information region (“CIR”) 406, a shared information region (“SIR”) 408, and/or an unconstrained device information region (“UIR”) 410.

At process block 304, a header is generated based on the generated transmission message. The header may include various information about the generated transmission message, as will be described in more detail below. The header includes data that can allow the one or more utility devices 150 receiving the broadcasted message to determine whether the broadcasted message include data packets applicable to the receiving utility devices 102. In one embodiment, the header is the CCR 402 described above, and the terms are understood to be used interchangeably herein. The CCR 402 may be generated based on the data contained within the generated transmission message 400. For example, the CCR 402 may include information as to whether there are data packets for groups of devices within the generated transmission message 400. For example, the CCR 402 may indicate whether the associated generated transmission message includes data associated with a broadcast type message, which is intended for all devices that receive the generated transmission message. Other data may include whether the associated generated transmission message includes data associated with constrained devices, which is intended for all devices that are designated as constrained devices (e.g., battery powered). Other data may include whether the associated generated transmission message includes data associated with shared devices, which is intended for all messages that are directed to a subsegment of both constrained and unconstrained devices. Finally, the header may include data which may include whether the associated generated transmission message includes data associated with unconstrained devices, which is intended for all devices that are designated as unconstrained devices (e.g., mains powered).

The CCR 402 may be of a known length and may include an explicit indication as to what type of information is contained in the payload of the data packets contained with the generated transmission message. This explicit indication enables both constrained and unconstrained devices to make real-time decisions as to whether or not to process data packets within the generated transmission message. Table 1, shown below, provides a first possible construction of a CCR region.

TABLE 1
CCR Frame Multiplexing Control Information Elements

| Information Element | Length | | |
|---|---|---|---|
| (IE) | (bits) | Value | Comments |
| BIR Present Flag | 1 | Boolean | 0% BIR not present |
| | | | 1% BIR present |
| CIR Present Flag | 1 | Boolean | 0% CIR not present |
| | | | 1% CIR present |
| SIR Present Flag | 1 | Boolean | 0% SIR not present |
| | | | 1% SIR present |
| UIR Present Flag | 1 | Boolean | 0% UIR not present |
| | | | 1% UIR present |
| Rsvd. | 1 | — | Set to 0% |
| ID Range Flag | 1 | Boolean | 0% Inside ID Range |
| | | | 1% Outside ID Range |
| Range Options | 3 | ENUM | 0 = All IDs |
| | | | 1 = Even IDs |
| | | | 2 = Odd IDs |
| | | | 3 = Mod 3 IDs |
| | | | 4 = Mod 4 IDs |
| | | | 5 = Mod 6 IDs |
| | | | 6 = Mod 8 IDs |
| | | | 7 = Mod 16 IDs |
| Lowest Target IDs | 16 | — | Lowest SID in Range |
| Highest Target IDs | 16 | — | Highest SID in Range |

As shown in Table 1, the CCR 402 may provide an indication as to whether the generated transmission message includes broadcast information data packets in the BIR 404, constrained device information data packets in the CIR 406, shared information data packets in the SIR 408, and/or unconstrained device information in the UIR 410. The CIR may further include information elements associated with unique network ID based operations, such as a flag indicating unique network ID based operations are required, unique network ID ranges, lowest target unique target ID, highest network ID ranges, and other information as required for a given application. Table 2, shown below, provides a second possible construction of a CCR region.

TABLE 2
CCR Frame Multiplexing Control Information Elements

| Information Element | Length | | |
|---|---|---|---|
| (IE) | (bits) | Value | Comments |
| BIR Present Flag | 1 | Boolean | 0% BIR not present |
| | | | 1% BIR present |
| CIR Present Flag | 1 | Boolean | 0% CIR not present |
| | | | 1% CIR present |
| SIR Present Flag | 1 | Boolean | 0% SIR not present |
| | | | 1% SIR present |
| UIR Present Flag | 1 | Boolean | 0% UIR not present |
| | | | 1% UIR present |
| Exclusion Zone Rules | 3 | ENUM | ENUM Rules Set |
| Target ID | 16 | — | Target device ID |

As shown in Table 2, the CCR 402 may provide an indication as to whether the generated transmission message includes broadcast information data packets in the BIR 404, constrained device information data packets in the CIR 406, shared information data packets in the SIR 408, and/or unconstrained device information in the UIR 410. The CCR 402 may further include information elements associated with one or more exclusion zone rules (described in detail below) and target unique network ID values. The CCR 402 is designed to allow a receiving device to efficiently determine whether the generated transmission message includes any data packets relevant to the receiving utility device 150, as will be described in more detail below.

The BIR region 404 may include data packets associated with a broadcast-type message for all utility devices 150 capable of receiving the generated transmission message 400. The CIR 406 may include data packets associated with constrained devices only with. The SIR 408 may include data packets associated with both constrained and unconstrained devices, and the UIR 410 includes data packets associated only with unconstrained devices.

Thus, the CCR 402, as described above, provides data to allow for the relevant utility devices 150 to determine whether the generated transmission message is relevant. The following figures provide various examples of how a header may organize, group, or otherwise define a portion of the possible unique network addresses to which a generated transmission message is relevant.

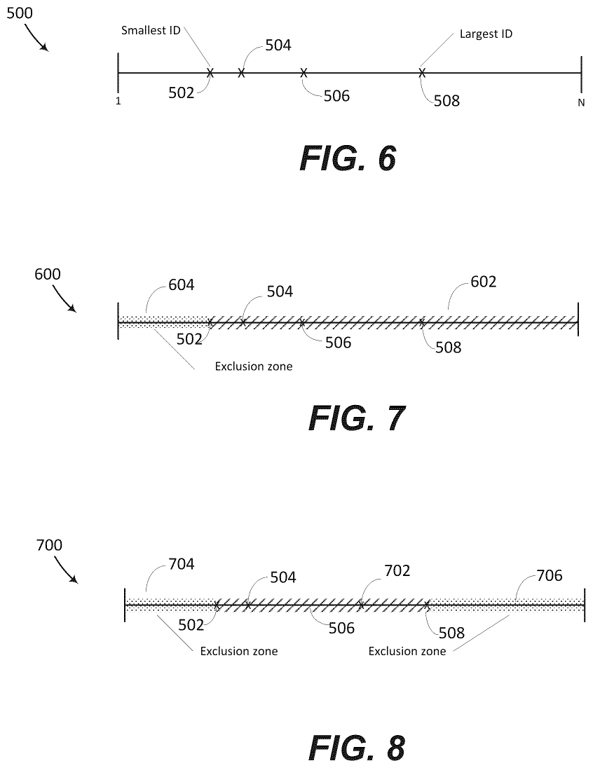

As described above, the CCR 402 may include one or more rules for generating exclusion zones for groups of devices, such as constrained devices. This can allow for constrained devices, upon determining that generated transmission message 400 includes data packets directed to unconstrained devices, to efficiently determine whether the generated transmission message includes data packets for specific utility devices 150 based on their unique network IDs. Turning now to FIG. 6, a line chart representing a generated transmission message 500 directed to a number of utility devices, such as utility devices 104a-f, is shown, according to some embodiments. FIG. 6 illustrates a general and known broadcast transmission in which the message is broadcast to all utility devices but is only directed to specific utility devices. As shown in FIG. 6, the generated transmission message is only relevant to utility devices 502, 504, 506, and 508. It should be understood that the utility devices 502, 504, 506, and 508 may be similar to the utility devices described herein, including utility devices 104a-f. As shown in FIG. 6, utility device 502 may have the smallest unique network ID, and utility device 504 may have the largest unique network ID (e.g., the value closest to N, where N is the total number of utility devices within the utility network).

In the example of FIG. 6, no rules or other data may be provided in the header associated with the generated transmission message 500, such that upon the generated transmission message 500 being broadcasted, any utility device receiving the generated transmission message 500 would be required to monitor the entirety of the generated transmission message to determine whether any of the data packets within the generated transmission message are associated with the receiving utility devices. This requires the receiving utility devices to remain in a listening mode for the entire duration of the generated transmission message, which may increase the energy consumption of the respective utility devices.

Turning now to FIG. 7, a modified generated transmission message 600 is shown, according to some embodiments. The modified generated transmission message 600 includes an inclusion zone 602 and an exclusion zone 604. As shown in FIG. 7, the inclusion zone is configured to include all unique network IDs greater than or equal to the unique network ID of the utility device having the smallest unique network ID, which in this case is utility device 502. The exclusion zone 604 therefore includes all of the utility devices having unique network IDs less than the unique network ID of utility device 502. The inclusion zone 602 and the exclusion zone 604 may be defined by a header associated with the generated transmission message 600, such as described above. For example, the header may include the unique network ID associated with utility device 502 and one or more rules in a header, such as the CCR 402 described above. The rules provide an indication that there are no data packets within the generated transmission message 600 for utility devices having a unique communication ID value less than the unique communication ID value of utility device 502. Thus, by reading the header of the generated transmission message upon receipt, any utility devices in the utility network with a unique network ID value less than that of the utility device 502 can quickly determine that the generated transmission message 600 is not relevant to them and can resume operating in a sleep or standby mode, as will be described in more detail below.

Turning now to FIG. 8, an outer exclusion zone generated transmission message 700 is shown, according to some embodiments. The outer exclusion zone generated transmission message 700 includes an inclusion zone 702 and a first exclusion zone 704, and a second exclusion zone 706. As shown in FIG. 8, the inclusion zone 702 is configured to include all unique network IDs associated with utility devices 502, 504, 506, 508 that are intended recipients of the outer exclusion zone generated transmission message 700. The first exclusion zone 704 includes all the utility devices having unique network ID values less than that of the utility device having the lowest unique network ID value, such as utility device 502. The second exclusion zone includes all the utility devices having unique network ID values greater than that of the utility device having the highest unique network ID value, such as utility device 508. The inclusion zone 702 and/or the first exclusion zone 704 and the second exclusion zone 706 may be defined by a header associated with the outer exclusion zone generated transmission message 700, such as described above. For example, the header may include the unique network ID associated with utility device 502 and the unique ID associated with the utility device 508, and one or more rules or other functions. The rules provided in the header may provide an indication that the outer exclusion zone generated transmission message 700 does not contain data packets for utility devices with unique network ID values below the unique network ID associated with the utility device 502 and utility devices having unique network ID values above the unique network ID associated with the utility device 508. Thus, by reading the header upon receipt of the outer exclusion zone generated transmission message 700, any utility devices in the utility network with a unique network ID value less than that of the utility device 502, or greater than that of the utility device 508 can determine that the outer exclusion zone generated transmission message 700 is not relevant and resume operating in a sleep or standby mode, as will be described in more detail below.

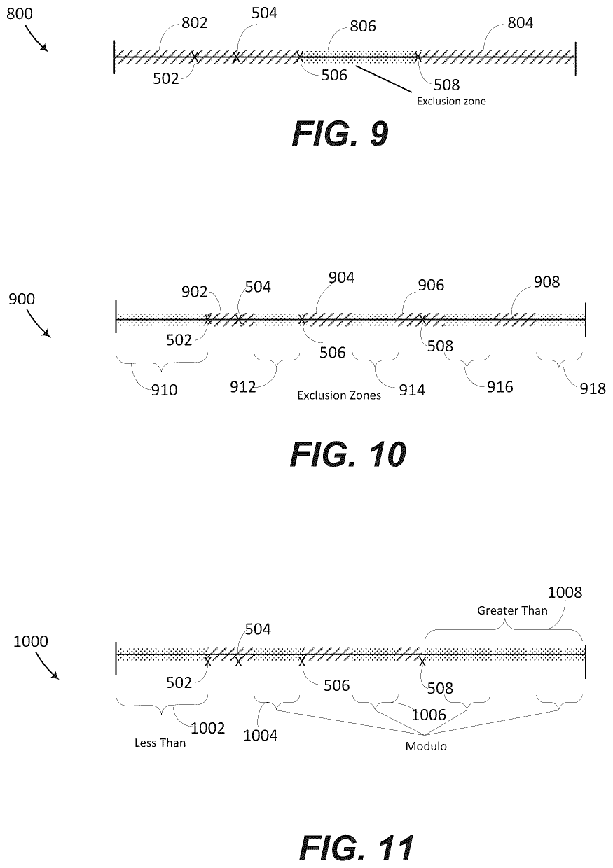

Turning now to FIG. 9, an inner exclusion zone generated transmission message 800 is shown, according to some embodiments. The inner exclusion zone generated transmission message 800 includes a first inclusion zone 802, a second inclusion zone 804, and an exclusion zone 806. As shown in FIG. 9, the first inclusion zone includes the unique network IDs associated with the utility devices 502, 504, 506, and the second inclusion zone 804 includes the unique network ID associated with the utility device 508, such that all intended recipient utility devices are included within either the first inclusion zone 802 or the second inclusion zone 804. The exclusion zone 806 includes all the utility devices having unique network ID values between the unique network ID value of utility device 506 and the unique network ID value of utility device 508. The first inclusion zone 802, the second inclusion zone 804, and the exclusion zone 806 may be defined by a header associated with the inner exclusion zone generated transmission message 800, such as described above. For example, the header may include the unique network ID associated with the utility device 506 and the unique network ID associated with the utility device 508. The header may also include one or more rules or other functions. The rules provided in the header may provide an indication to utility devices receiving the inner exclusion zone generated transmission message 800 that utility devices having unique network ID values between the unique network ID value of utility device 506 and the unique network ID value of the utility device 508 can ignore the message as there are no data packets for utility devices having unique network ID values in that range. Thus, by reading the header upon receipt of the inner exclusion zone generated transmission message 800, any utility devices in the utility network with a unique network ID value values between the unique network ID value of utility device 506 and the unique network ID value of the utility device 508 can determine that the inner exclusion zone generated transmission message 800 is not relevant and resume operating in a sleep or standby mode, as will be described in more detail below.

Turning now to FIG. 10, a periodic exclusion zone generated transmission message 900 is shown, according to some embodiments. The periodic exclusion zone generated transmission message 900 includes a number of inclusion zones 902, 904, 906, and 908, and a number of exclusion zones 910, 912, 914, 916, and 918. The inclusion zones 902, 904, 906, 908 and/or the exclusion zones 910, 912, 914, 916, 918 may be based on one or more functions, such as a modulo (“mod”) function. For example, mod functions such as mod3, mod4, mod5, mod6, mod8 and/or mod16 may be used to define the exclusion zones 910, 912, 914, 916, 918. While the above functions are described as mod functions, it is contemplated that other functions may also be used. In one embodiment, a utility system, such as utility system 102, generating the periodic exclusion zone generated transmission message 900 may determine an appropriate periodic function that ensures that all utility devices having data packets within the generated message are outside of the exclusion zones 910, 912, 914, 916, 918.

The inclusion zones 902, 904, 906, 908 and the exclusion zones 910, 912, 914, 916, 918 may be defined by a header associated with the periodic exclusion zone generated transmission message 900, such as described above. For example, the header may include the unique network ID associated with the utility device 502 and the unique network ID associated with the utility device 508. The header may also include one or more rules as described above. The rules provided in the header may provide an indication to utility devices receiving the periodic exclusion zone generated transmission message 900 that a function, such as a mod function based on at least one unique network ID value, such as the unique network ID value associated with the utility device 502, is required to determine which utility devices are the intended recipient of the periodic exclusion zone generated transmission message 900. Thus, by reading the header upon receipt of the periodic exclusion zone generated transmission message 900 and performing the required function (e.g., mod function), the receiving utility device can determine whether the periodic exclusion zone generated transmission message 900 is relevant to said receiving utility device (e.g., contains a data packet for the receiving utility device). In response to the receiving utility device determining that the received periodic exclusion zone generated transmission message 900 is not relevant, the receiving utility device can resume operating in a sleep or standby mode, as will be described in more detail below.

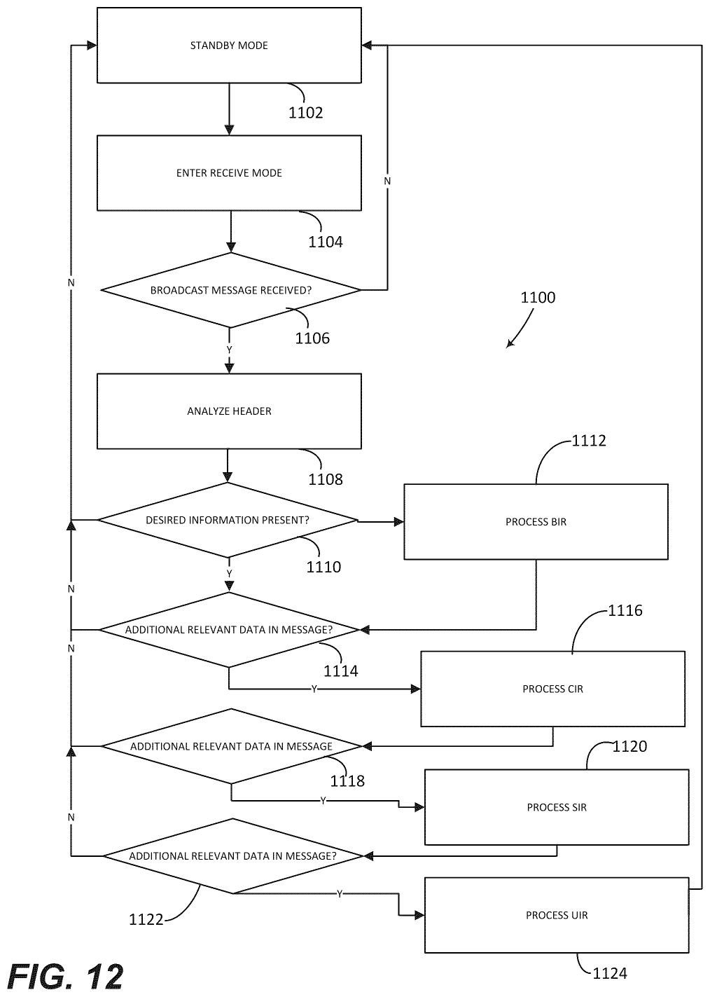

Turning now to FIG. 11, a multi-function exclusion zone generated transmission message 1000 is shown, according to some embodiments. The multi-function exclusion zone generated transmission message 1000 may use various functions to create multiple exclusion zones. For example, a first exclusion zone 1002 may include any utility devices having unique network ID values less than the unique network ID value of utility device 502. Exclusion zones 1004, 1006 may be based on a periodic function, such as a mod function, and exclusion zone 1008 may be based on a combination of the periodic function and further configured to include all utility devices having unique network ID values greater than the unique network ID value of utility device 508.

Similar to above, a header associated with the multi-function exclusion zone generated transmission message 1000 may be used by a receiving device to determine the exclusion zones 1002, 1004, 1006, 1008. For example, the header may include the unique network ID associated with the utility device 502 and the unique network ID associated with the utility device 508. The header may also include one or more rules as described above. The rules provided in the header may provide an indication to utility devices receiving the multi-function exclusion zone generated transmission message 1000 as to what functions, unique network ID values, etc., are required to determine which utility devices are the intended recipient of the multi-function exclusion zone generated transmission message 1000. Thus, by reading the header upon receipt of the multi-function exclusion zone generated transmission message 1000 and performing the required functions and/or evaluations, the receiving utility device can determine whether the multi-function exclusion zone generated transmission message 1000 is relevant to said receiving utility device (e.g., contains a data packet for the receiving utility device). In response to the receiving utility device determining that the received multi-function exclusion zone generated transmission message 1000 is not relevant, the receiving utility device can resume operating in a sleep or standby mode, as will be described in more detail below.

The above example message types and their respective inclusion/exclusion zones are for exemplary purposes, and it is understood that various other functions may be used to set exclusion zones, such as even/odd unique network ID value rules, multi-range rules, or the like. Furthermore, the functions and rules described above may be expanded or varied as required for a given application.

Returning now to FIG. 4, at process block 306 the generated transmission message including the generated header is broadcast at process block 306 as a broadcast message. The broadcast message may be transmitted using a wireless communication protocol as described above.

Turning now to FIG. 12, a process 1100 for processing broadcast messages at a utility device, such as utility devices 150 is described, according to some embodiments. At process block 1102, the utility device 150 operates in a standby mode. In some examples, the standby mode may be described as a sleep mode. In the standby mode, the utility device 150 generally is configured to consume a minimal amount of power. For example, the utility device 150 is generally unable to receive communications from other devices, such as the utility system 102, when operating in the standby mode. At process block 1104, the utility device 150 enters a receive mode for receiving communications. In some examples, the utility device 150 enters the receive mode at set periodic intervals. Example periodic intervals may be 30 second intervals, intervals, etc. However, any interval may be used as required for a given application. In other embodiments, such as where the utility device includes a real-time clock, the utility device 150 may enter the receive mode at certain times of the day, which may allow multiple utility devices 150 with the utility network 100 to synchronize the entry into the receive mode. While in the receive mode, the utility device 150 is configured to receive messages, such as wireless messages broadcast by the utility system 102. In some examples, the utility device 150 is configured to operate in the receive mode for a predetermined time.

At process block 1106, the utility device determines whether a broadcast message has been received. In one embodiment, the broadcast message is transmitted by the utility system 102, such as via a wireless communication protocol as described above. In response to determining that no broadcast message was received, the utility device 150 returns to standby mode at process block 1102. In response to determining that a broadcast message was received, the utility device 150 analyzes a header of the received broadcast message at process block 1108. In some embodiments, the header may be the CCR 402 described above. The utility device 150 may analyze the header of the received broadcast message to determine whether the broadcast message is relevant (e.g., includes any data packets for the utility device 104) to the utility device 104. As described above, the header may include various information, such as which data regions (e.g., BIR 404, CIR 406, SIR 408, and/or UIR 410) have associated data packets within the received broadcast message. The utility device 150 may determine, using the header, whether any of the information regions having data packets are applicable to the utility device 150.

At process block 1110, the utility device 150 determines whether there is any relevant desired information within the received broadcast message. For example, the utility device 150, based on the devices type (e.g., constrained or unconstrained), may evaluate the header to determine whether any data packets are relevant to the utility device 150. For example, where the utility device 150 is a constrained device, the utility device 150 may determine that no data packets are applicable in response to the header indicating that data packets only exist in the unconstrained data region. In contrast, in response to the header indicating that the data packets within the information regions of the broadcast message are relevant, such as where data exists in the BIR 404 and/or CIR 406, the utility device 150 may determine that there are relevant data packets within the received broadcast message.

In response to determining that no relevant data is present in the received broadcast message, the utility device resumes operation in the standby mode at process block 1102. In response to determining that relevant data is present, the utility device processes data packets in the BIR 404 at process block 1112. The BIR 404 is processed first as it is presented first in the message, as described above. However, other messages may be arranged as required for a given application and it is understood that the process 1100 can be adjusted accordingly. In response to processing data packets within the BIR 404, the utility device 150 determines whether there are any additional relevant data packets in the message (e.g., relevant data in the CIR 406, SIR 408, and/or UIR 410) at process block 1114. In response to determining that no additional relevant data packets remain in the received broadcast message, the utility device 150 resumes operating in the standby mode at process block 1102. In response to determining that additional relevant data packets remain in the received broadcast message, the utility device process data packets in the CIR 406 at process block 1116.

In response to processing the data packets in the CIR 406, the utility device 150 determines whether there are any additional relevant data packets in the received broadcast message (e.g., relevant data in the SIR 408, and/or UIR 410) at process block 1118. In some examples, the utility device 150 may be configured to know whether it is part of any shared groupings that would require a data packet in the SIR 408. However, in other examples, the utility device 150 may be configured such that any indication of data packets in the SIR 408 requires the SIR 408 to be processed for possible relevant data. In response to determining that no additional relevant data packets are in the received broadcast message, the utility device 150 resumes operating in the standby mode at process block 1102. In response to determining that additional relevant data packets remain in the received broadcast message, the utility device 150 processes the SIR 408 at process block 1120. In response to processing the SIR 408, the utility device 150 determines whether there are any additional relevant data packets in the received broadcast message (e.g., relevant data in the SIR 408, and/or UIR 410) at process block 1122. In response to determining that no additional relevant data packets are in the received broadcast message, the utility device 150 resumes operating in the standby mode at process block 1102. In response to determining that additional relevant data packets remain in the received broadcast message, the utility device 150 processes the UIR 410 at process block 1124. In response to processing the UIR 410, the utility device 1102 resumes operating in the standby mode at process block 1102.

While not described in detail, the utility device 150 may process data in the information regions, and specifically the CIR 406, using the one or more rules in the CCR 402, as described above.

In the foregoing specification, specific embodiments have been described. However, one of ordinary skill in the art appreciates that various modifications and changes may be made without departing from the scope of the disclosure as set forth in the claims below. Accordingly, the specification and figures are to be regarded in an illustrative rather than a restrictive sense, and all such modifications are intended to be included within the scope of present teachings.

Various features and advantages of some embodiments are set forth in the following claims.

What is claimed is:

1. A utility device within a utility system, comprising:
a power source;
a communication interface; and
one or more electronic processors, wherein the one or more electronic processors are configured to:
periodically transition from a standby mode to a receive mode;
monitor for a broadcast message while in the receive mode;
receive the broadcast message via the communication interface while in the receive mode;
analyze a header of the received broadcast message to determine whether any data packets within the broadcast message are relevant, wherein determining whether the data packets within the received broadcast message are relevant includes determining whether the received broadcast message includes one or more data packets within one or more information regions associated with a device type of the utility device; and
resume operation in the standby mode in response to determining that the received broadcast message does not include any relevant data packets.

2. The utility device of claim 1, wherein the one or more electronic processors are further configured to process the broadcast message in response to determining that the broadcast message includes one or more relevant data packets.

3. The utility device of claim 1, wherein the header includes one or more indications of which of the one or more information regions contain the one or more data packets associated with the device type of the utility device.

4. The utility device of claim 1, wherein the one or more information regions include at least one selected from a group consisting of a broadcast information region, a constrained device information region, a shared device information region, and an unconstrained device information region.

5. The utility device of claim 1, wherein the information regions are associated with specific device types of one or more utility devices within the utility system.

6. The utility device of claim 1, wherein the utility device is one of a constrained device and an unconstrained device.

7. The utility device of claim 6, wherein the constrained device has a limited power source.

8. The utility device of claim 7, wherein the limited power source is a battery.

9. A method for generating broadcast messages within a utility network, comprising:
generating a broadcast message, wherein the broadcast message includes one or more data packets associated with one or more utility devices;
generating a header for the generated broadcast message, wherein the generated header includes data indicating applicability of the included one or more data packets with the one or more utility devices; and
transmitting the generated message.

10. The method of claim 9, wherein the data includes indications that the one or more data packets within the generated broadcast message are intended for a group of devices within the utility network.

11. The method of claim 9, wherein the data includes indications that the one or more data packets within the generated broadcast message are intended for constrained devices or unconstrained devices.

12. The method of claim 11, wherein the constrained devices are battery-powered devices.

13. The method of claim 9, wherein the generated broadcast message includes a plurality of information regions, wherein the plurality of information regions include at least one selected from a group consisting of a common control region, a broadcast information region, a constrained device information region, a shared information region, and an unconstrained device information region.

14. The method of claim 13, wherein the common control region includes the header.

15. A method for analyzing broadcast messages at a utility device, comprising:
periodically transitioning from a first mode to a second mode;
receiving a broadcast message via a communication module while in the second mode;
analyzing a header of the received broadcast message to determine whether the received broadcast message includes one or more data packets within one or more information regions that are associated with a device type of the utility device;
determining whether the received broadcast message is a relevant message in response to determining that the received broadcast message includes one or more data packets within one or more information regions associated with the device type of the utility device; and
processing the received broadcast message in response to determining that the received broadcast message is a relevant broadcast message.

16. The method of claim 15, wherein the first mode is a standby mode and the second mode is a receive mode.

17. The method of claim 15, further comprising resuming operation in the first mode in response to determining that the received broadcast message is not a relevant broadcast message.

18. The method of claim 15, wherein the header includes one or more indications of which of the one or more information regions contain data packets associated with the device type of the utility device.

19. The method of claim 15, wherein the information regions include at least one selected from a group consisting of a broadcast information region, a constrained device information region, a shared device information region, and a constrained device information region.

20. The method of claim 19, wherein constrained devices are battery powered devices.
